(19) United States
(12) Patent Application Publication
(10) Pub. No.: US 2003/0120592 A1
(43) Pub. Date: Jun. 26, 2003

(54) Method of performing a transaction

(76) Inventor: Fook Sun Ng, The Meyer Place (SG)

Correspondence Address: GREENBLUM & BERNSTEIN, P.L.C., 1950 ROLAND CLARKE PLACE, RESTON, VA, 20191, US

(21) Appl. No.: 10/204,423

(22) PCT Filed: Feb. 22, 2001
(86) PCT No.: PCT/SG01/00047

(30) Foreign Application Priority Data
Mar. 3, 2000 (SG) 200001130-4

(51) Int. Cl. G06F 17/60

(52) U.S. Cl. 705/39

(57) ABSTRACT

A method of performing a transaction over the Internet between a customer (1) and a vendor (2) using a payment card issued by a card company is disclosed, comprising the steps of: prior to any transaction using the method, assigning and advising a customer of an identifier corresponding to a payment card number of the customer's payment card and storing the identifier with the card number and a telephone number of the customer (1): and at the time the transaction occurs, receiving the identifier from the customer (1) over the internet, establishing the card number from the identifier, calling the customer using the telephone number to confirm the transaction, obtaining authorization of the confirmed transaction from the card company (5) and communicating the authorization to the vendor (2).

### BACKGROUND AND FIELD OF THE INVENTION

This invention relates to electronic (e-) commerce, in particular to a method of performing transactions (e.g. credit, debit or charge card) over the Internet or other data network.

In an e-commerce transaction, a user (customer) will go to a desired merchant's on-line site either by surfing the world-wide-web to reach the merchant's website or, via a dedicated network, logging into either the merchant's server directly or on to a trading community's server.

Once there, the user will select the products or services to be purchased. The user then proceeds to a payment instruction screen and typically the settlement is made with a credit card. The user keys in his credit card information which is sent to the merchant The merchant then typically (not necessarily) sends the number on-line to the acquiring bank to verify that the credit card number is active (i.e. not suspended). If the acquiring bank confirms that the credit card number is valid, the merchant then proceeds to deliver the products/services to the user. After a period of time (e.g. few days or whatever has been agreed), the acquiring bank pays the merchant.

With the above process there are several problems which can be divided into two groups, those faced by the user and those faced by the merchant.

Concerning the user, when making the payment instruction, the user is required to key in his credit card information which is then transmitted over the Internet. The Internet is a public network so that data traversing this medium is not secure and open to ‘snooping’. Various methods have been proposed including encryption of this data to prevent unauthorized access, use of SSL being the most common. While this increases the level of security, no system is perfect as long as the data is there. Additionally, users may fear that they are sending their credit card information to a fraudulent vendor who has no intention of delivering any goods but only in capturing the credit card information for fraudulent use. As a result of this risk, many users do not want to use their credit card number over the Internet and this has caused a breakdown in confidence in the present e-commerce scheme, thereby hindering growth of e-commerce.

Concerning the merchant, when the merchant receives the credit card information from the user (customer), he can only verify through the acquiring bank if the card identified by the information is valid and active, or not. The merchant is not able to verify if the credit card information was passed to him by the bona fide owner or by someone ‘posing’ as the owner. The existing credit card policy, under what is known as MOTO transactions (Mail Order Telephone Order) states that in the event that the credit card is not physically sighted (and thereby the owner does not physically sign the payment slip), the owner of the card is able to repudiate or reject payment for the transaction unless the merchant is able to prove otherwise that the bona fide user executed the transaction. In most e-commerce cases, this is not possible. As a result, credit card fraud for e-commerce is very high causing high losses to the merchants and in extreme cases, causing the merchant to cease to use e-commerce altogether.

It is an object of the invention to provide a method of performing a payment card transaction over the internet which alleviates at least one of the aforementioned disadvantages of the prior art.

### SUMMARY OF THE INVENTION

According to the invention in a first aspect there is provided a method of performing a transaction over a data network between a customer and a vendor using a payment card or account, comprising the steps of:

prior to a transaction using the method, assigning and advising a customer of an identification code associated with the number of the card or account and storing the identification code in association with the card or account number; and

at the time the transaction occurs, receiving the identification code from the customer over the data network, establishing the card or account number from the identification code, communicating with the customer telephonically to confirm the transaction, obtaining an authorization of the confirmed transaction using the card or account number and communicating the authorization to the vendor.

Preferably, prior to the transaction a confirmation code is provided to the customer and at the time of the transaction, the customer confirms the transaction using the confirmation code. The confirmation code may be a PIN or may be related to the biometrics of the customer.

Preferably, prior to a transaction, a telephone number of the customer is stored in association with the identification code and the method may further comprise the step, at the time the transaction occurs, of calling the customer using the telephone number to confirm the transaction or of the customer calling from the telephone number to confirm the transaction.

The payment card is preferably a credit card, debit card or charge card.

The identification code may be associated with more than one payment card or account with the method further comprising the step of requesting a selection of payment card/account by the customer. The selection may be made at the time the customer confirms the transaction.

The step of communicating with the customer telephonically may be via one of a mobile telephone link or a fixed-line.

The step of obtaining authorization of the confirmed transaction may comprise the step of the vendor's bank seeking authorization of the confirmed transaction from an institution associated with the payment card or account. The identification code may be stored in a central registry with the central registry informing the vendor's bank of the card or account number or the vendor's bank sends the identification code to the central registry which seeks authorization from the institution on behalf of the vendor. The institution may include the customer's bank, credit card company or a utility company.

The identification code is preferably in a compatible format to the payment card or account number.

The customer also preferably provides, at the time the transaction occurs, an identifier which identifies a transaction using the method and the identifier may comprise modified name information of the payment card or account or may form part of the identification code. Preferably at the time the transaction occurs, the customer also provides payment card expiry date information or a substitute therefor.

According to the invention in a second aspect, there is provided a method of modifying a payment card transaction over a data network in which a customer supplies payment card information to a vendor on-line, said information comprising a payment card number, a card name and a card expiry date and the information is supplied by the customer completing a virtual form to be sent to the vendor, the form having fields of a fixed configuration to receive the information, the modification comprising the steps of, prior to a transaction using the method, assigning and advising the customer of an identification code corresponding to the payment card number to be used in place thereof and storing the identification code in association with the card number; and

at the time the transaction occurs, determining if a said identification code has been sent by the customer and if so, establishing the card number from the identification code, communicating with the customer telephonically to confirm the transaction and obtaining an authorization of the confirmed transaction using the card number and, if not, seeking authorization of the card number directly, and communicating the authorization to the vendor.

The payment card may be a physical card or a virtual card.

The data network may be the Internet or any other data network.

The invention extends to apparatus for performing the claimed methods.

In the described embodiment of the invention, no card or account information is passed by the customer over the data network to the vendor. The customer can simply send a pre-registered identification code which in itself is of no use if intercepted since it is not the code which confirms the transaction which is performed subsequently by the customer using the telephone. The step of confirmation by the customer provides a way for the vendor to confirm that the payment instruction is given by the bona fide user of the payment card.

The described embodiment offers authorization by the registered user for unsighted credit card transactions (in an electronic way similar to having a user sign in black & white on the payment slip). The described embodiment uses commonly available digital cellular (or fixed line) telephones e.g. GSM, as an ID device to obtain authentication from the bona fide user. Digital phones e.g. GSM encrypt their identification number and also its transmission making this a secure channel. Combined with an optional secret PIN that the user keys in during the transaction process, make the telephone a mobile authentication device. Communication between the Central Registry and the mobile phone may be through standard network supported voice or data messaging, for example (but not limited to) simple DTMF signalling (Dual-Tone-Multi-Frequency) over a standard circuit switched network such that no enhancements or new features are required of the service/network provider. However, the invention does not exclude the use of an enhanced dedicated messaging system to facilitate communication. The interactive and active use of a telephone to authenticate and confirm the identity of the cardholder may be deemed to be equal to a physical signature on a vendor receipt that authorizes a contract between a vendor and a customer. The described embodiment also uses existing credit card payment infrastructure without having the user transmit his credit card information over the Internet for every transaction (this information is sent once to the Central Registry and thereafter kept in its record).

Normal MOTO credit card transactions (i.e. unassisted by the method of the described embodiment) are still able to be processed since the described embodiment is compatible with the existing clearance system available today and will not disrupt it.

No special software or plug-in is required for the user and off-the-shelf web browsers, electronic wallets, form fillers etc. will work since the described embodiment requires no modification in the user-side software. No special software is further required for the merchant and off the shelf, 3^{rd} party software that supports on-line credit card clearance with the acquiring bank will work. The described embodiment is transparent to the merchant's software as long as this supports on-line credit card clearance e.g. through a payment gateway or directly with the acquiring bank can be employed with the described embodiment. However, while standard 3^{rd} party software can be used, users or merchants may choose to enhance its software if so desired. The described embodiment is transparent to the merchant's software as long as this supports on-line credit card clearance with the acquiring bank. The described embodiment is able to work on standard digital cellular phones e.g. GSM and does not require any special or new features and does not require any special software or modifications from the network provider.

It is to be appreciated that the described embodiment (and the mentioned advantages thereof) is exemplary only and the invention is to be construed with reference to the appended claims without limit to the embodiment described.

### BRIEF DESCRIPTION OF THE DRAWINGS

An embodiment of the invention will now be described, by way of example, with reference to the accompanying drawings in which:

FIG. 1 illustrates the parties to a transaction using the described embodiment of the method of the invention; and

FIGS. 2A-2C show the transaction steps when using the method of the described embodiment of the invention.

### DETAILED DESCRIPTION OF THE PREFFERED EMBODIMENT

A transaction using the method will now be described involving use of a credit card over the Internet. However, it will be understood by those skilled in the art that the described method is equally applicable for use with other types of payment card such as charge cards and debit cards over other kinds of data network such as a Wireless Application Protocol (WAP) network.

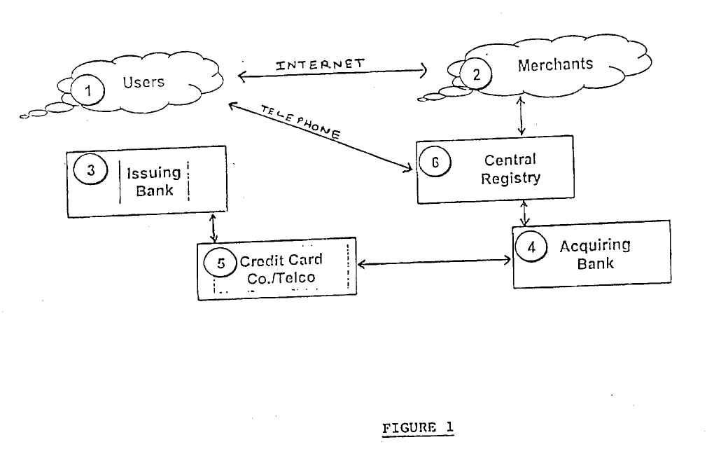

The parties to the transaction are shown in FIG. 1:

Users (Customers) (1): Internet businesses or individual consumers that conduct commerce over the Internet. Current payment methods targeted include credit card and on-line debit payments

Merchants (Vendors) (2): Service providers or sellers over the Internet. This entity includes businesses selling to businesses, and businesses selling to individual consumers.

Issuing Bank (3): Issuers of credit cards or on-line debit services

Acquiring Bank (4): Acquirers of credit card and/or debit card merchant transactions in the Internet Commerce or physical payments world.

Credit Card Company (5): The issuer of the credit card such as Visa and MasterCard.

Central Registry (6): A clearing and settlement facility that provides basis for identification with non-repudiation.

The parties to the transaction are similar to the parties to a standard MOTO credit card settlement process discussed in the prior art. While the figures do not explicitly present the Internet infrastructure such as Internet portals and websites, it is implicit that there may be such intermediaries between a customer or a business and the central registry. The only difference is that the central registry is located with either the acquiring bank or with the credit card company for the purpose of validating and authenticating the user so that the credit card transaction becomes non- repudiable. The user 1 and merchant 2 are connected by the Internet. The connections between the merchant 2, central registry 6, acquiring bank 4 credit card company 5 and issuing bank 3 are by secure fixed lines. Central registry 6 also has an ability to telephone the user via a fixed or mobile line.

In a pre-transaction registration phase, a user 1 registers with the central registry 6 by providing details of the credit card, in particular the credit card number and, optionally, name and expiry date. The user may register more than one credit card of any other payment method but must indicate the preferred default payment card. The central registry then confidentially issues the user with an identification code, which may be of any format for example numerical or alpha-numerical but generally one that can be readily input using a computer keyboard and instructions for use in a transaction using the method. The format of the identification code is flexible according to implementation but must fulfil the following criteria (a) it should be distinguishable uniquely from a ‘normal’ card information (b) it should be able to pass through standard software seamlessly for example by being in a format similar to a ‘normal’ card. One example of an implementation is as follows:

1. For the name field of the card, is prefixed with a transaction identifier ‘TELEMONEY’ e.g. Joe Schmo becomes ‘TELEMONEY Joe Schmo’

This field is used for the identifier since it usually is of sufficient length to allow the identifier to be included. Alternatively, the identifier can be included in the identification code (below), for example by using a unique identifier for transaction using the described embodiment, in the first four digits of the code.

2. For the card number field, a unique identification code is assigned, with the same field sequence as a standard credit card eg. XXXX-XXXX-XXXX-XXXX where “X” is a number from 0-9. Such a sequence is used in Visa and Mastercard, for example but other field sequences are used, for example by Diners Club which uses an XXXX-XXXXXX-XXXX format. Existing credit card transaction software can deal with these different kinds of numbers already and only a requirement that the unique identification code is able to be passed on seamlessly through such software in a similar manner to a credit card number. The identification code may (but need not) be selected in dependence upon the format of the payment card with which it is associated.

3. For the card expiry date field either this can remain the same or a substitute expiry date in the same month-year format i.e. MM-YY is assigned, for example relating to the expiry of usage of the transaction method.

(1) and (3) above need not be used, according to implementation.

A user further provides the central registry with a telephone number with which the central registry can contact the user to confirm the transaction as will be hereinafter described and may be issued with a confidential confirmation code for this purpose. The confirmation code may be of any type, for example a PIN or a code other than a number, for example based on voice pattern recognition, with the user of providing, in a registration phase, a spoken phrase which, when prompted for the code subsequently, he speaks into his mobile phone. Other biometrics or other kinds of confirmation codes may also be used. Preferably, the telephone number is of a mobile phone or two-way pager although, if the user can be sure that he will be contactable over a fixed line at his computer terminal, a fixed line telephone number can be given.

In subsequent transactions, as will be described, the user uses the identification code in exactly the same manner as he would use his credit card number in an ordinary Internet transaction. The identification code provides two functions. The first is to provide information that enables the central registry 6 to distinguish the identification code from any ordinary credit card number which is received and the second is to provide a means to allow the user to be identified uniquely.

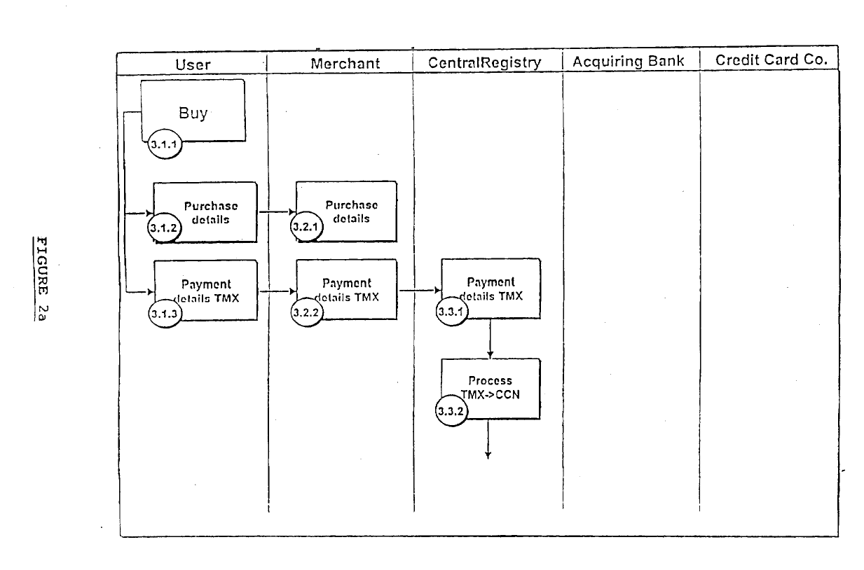

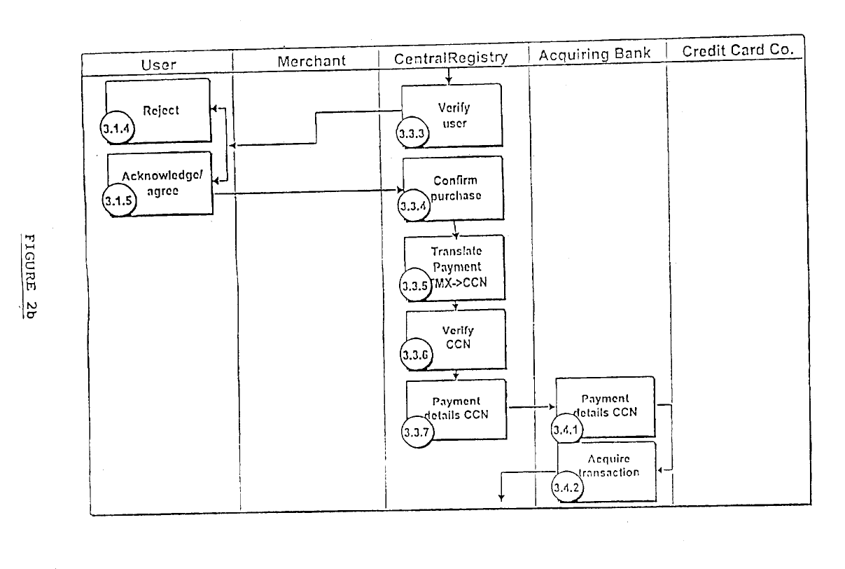

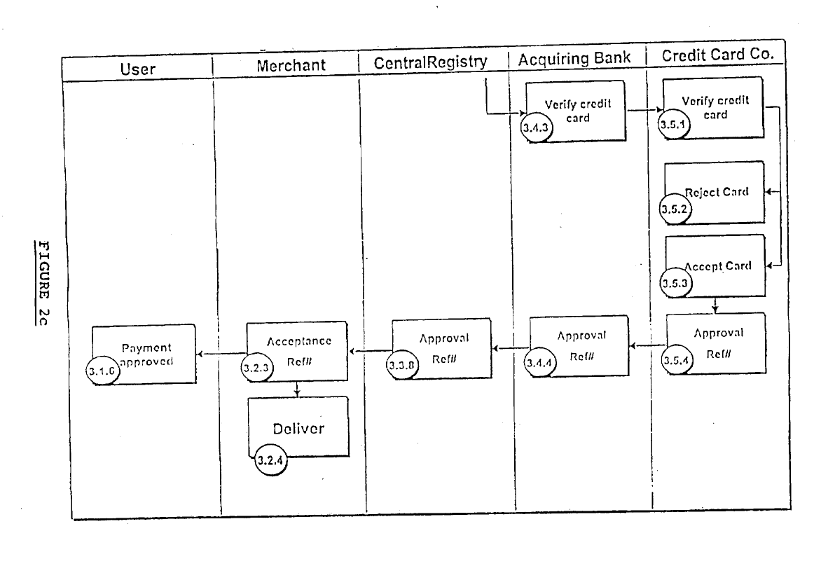

Once this initial registration phase has been completed, the user then performs Internet transactions in accordance with the following steps, shown in FIG. 2:

In step 3.1.1 the user reaches the on-line site of the merchant and decides that he wishes to purchase a product or service.

The user then selects products to be purchased (3.1.2) and proceeds to the payment instructions which will involve the completion of a virtual form having predefined fields for the credit card information. There he will select payment by credit card but instead of keying in his credit card information, he will key in his identification information (3.1.3) which was passed to him by the Central Registry during the earlier registration process. The identification information (TMX) follows the same field and description format as the standard credit card information i.e. a name field (TM_NAME) which comprises the card name preceded by an identifier (e.g. TELEMONEY, as described above), credit card number (TM_CC#) which comprises the identification code and an expiry date (TM_EXP). Some sites may not require the name and expiry date information, in which case the identification code is all that is entererd.

The user's purchase details and payment information are both passed on to the merchant via the on-line site (3.2.1 and 3.2.2). The merchant keeps the purchase to himself (to be used later on for delivery fulfillment) and passes on the payment information (TMX) to the Central Registry for clearance.

On receipt of a payment clearance request by the merchant (3.3.1) the Central Registry begins a process to verify the user and the status of his credit card number (3.3.2). Based on the identification information (TMX), the Central Registry will check its database to retrieve the user's details (registered telephone number, PIN etc.) and his pre-selected credit card number to be billed for this transaction (CCN).

To verify the user (3.3.3), the Central Registry establishes a phone connection with the user's predefined mobile phone. Either the Central Registry can call the user or the user can call the Central Registry to establish this connection. Once the connection is established, the Central Registry may then either prompt the user to key in his secret PIN on his mobile phone or simply hit one key to confirm and a different key to reject payment for the transaction or to reject payment. If the user rejects payment (3.1.4), the transaction is aborted and the Central Registry immediately sends a message to the merchant to inform him that payment was rejected.

If the user decides to confirm payment (3.1.5), the Central Registry will receive the user's secret PIN and will cross-reference this PIN with the user's details stored in its database. If all the details check-out, the Central Registry will consider the payment as having been authorized by the bona fide user (3.3.4)

In parallel or sequentially, the Central Registry having received the identification information (TMX) for the payment clearance request, will translate the data into the registered user's credit card information (CCN) (3.3.5). This credit card information will need to be verified through the acquiring bank's network to ensure that it is active and that the available credit balance will cover the payment being requested for (3.3.6). To do this, the Central Registry sends the user's credit card information (CCN) to the acquiring bank through the existing settlement network (3.4.1)

The acquiring bank then proceeds to acquire the transaction (3.4.2) as with any other credit card transaction and proceeds to verify that the card number and the value to be paid through its existing settlement network with the credit card company (3.4.3 and 3.5.1 through 3.5.4). If the card number is active and the value is approved, then the acquiring bank will receive an approval reference back from the settlement network (3.4.4).

Having received the approval reference, the acquiring bank then notifies the Central Registry (3.3.8) which similarly sends a message to the merchant that the payment request has been approved (3.2.3)

The merchant, on receiving the approval reference from the Central Registry will then complete the transaction process by optionally informing the user that the payment instruction has been approved (3.1.6) by providing an electronic receipt (which receipt may be given over the Internet connection, by separate e-mail or may be directed back to the central registry for onward transmission to the user's mobile telephone as a SMS message) and then subsequently following through with the delivery of the product or service (3.2.4).

At step 3.3.2, if the Central Registry determines that the identification information does not include an identification code and is, consequently a normal credit card number, the Central Registry jumps directly to step 3.4.1 so that the identification information is passed directly to the acquiring bank.

Although an embodiment of the method of the present invention has been described to a credit card transaction over the internet, this is not to be construed as limitative and the invention is equally applicable for use with other kinds of payment cards, for example debit cards or charge cards using other data networks. Such cards may be both physical or virtual (i.e. the physical card need not exist, the “card” being identified by the account information). For debit cards which are issued directly by a bank and not via a credit card company, the acquiring bank will confirm the transaction directly with the issuing bank. Furthermore, although the described embodiment has been shown with the merchant contacting the central registry which then contacts the acquiring bank, this is not to be construed as limitative. For example, the central registry may have a different position in the back-end, e.g.:

a. between the merchant & the acquiring bank

b. between the acquiring bank & the credit card co.

c. ‘with’ the merchant

d. ‘with’ the acquiring bank

e. ‘with’ the credit card co.

f. ‘with’ the issuing bank

g. between the credit card co. and the issuing bank

Streaming of transactions received by the merchants into those with normal credit card numbers and those with identification codes need not be made by the central registry but may, for example, be made by the acquiring bank.

Furthermore, the identification code may be associated with more than one payment card, account or method, with a selection of account to be used being made by the user using his mobile phone at the time the notification of transaction and request for a confirmation code is received. Furthermore, the institution associated with the payment need not be a bank or credit card company but may, for example, be a finance company, utility company such as a telephone company or any other institutions with which the customer has a financial arrangement which allows payments to be made. For many such institutions, such as a utility company, the “payment card” would be wholly virtual in nature with the identification code simply being associated with an account number for the utility company from which any purchases would be debited.

The use of the identification code thus provides a high degree of flexibility in the method of payment that may be used depending upon the accounts, payment methods and payment institutions which are associated with the identification code.

1. A method of performing a transaction over a data network between a customer and a vendor using a payment card or account, comprising the steps of:
prior to a transaction using the method, assigning and advising a customer of an identification code associated with the number of the payment card or account and storing the identification code in association with the card or account number; and, at the time the transaction occurs, receiving the identification code from the customer over the data network, establishing the card or account number from the identification code, communicating with the customer telephonically to confirm the transaction, obtaining an authorization of the confirmed transaction using the card or account number and communicating the authorization to the vendor.

2. A method as claimed in claim 1 wherein prior to the transaction a confirmation code is provided to the customer and at the time of the transaction, the customer confirms the transaction using the confirmation code.

3. A method as claimed in claim 2 wherein the confirmation code is a PIN or is related to the biometrics of the customer.

4. A method as claimed in any one of claims 1 to 3 wherein, prior to a transaction, a telephone number of the customer is stored in association with the identification code.

5. A method as claimed in claim 4 further comprising the step, at the time the transaction occurs, of calling the customer using the telephone number to confirm the transaction.

6. A method as claimed in claim 4 further comprising the step, at the time the transaction occurs, of the customer calling from the telephone number to confirm the transaction.

7. A method as claimed in any one of the preceding claims wherein the payment card is a credit card, debit card or charge card.

8. A method as claimed in any one of the preceding claims wherein the identification code is associated with more than one payment card or account and further comprising the step of the customer selecting a payment card/account.

9. A method as claimed in claim 8 wherein the selection is made at the time the customer confirms the transaction.

10. A method as claimed in any one of the preceding claims when the step of communicating with the customer telephonically is via one of a mobile telephone link or a fixed-line.

11. A method as claimed in any one of the preceding claims wherein the step of obtaining authorization of the confirmed transaction comprises the step of the vendor's bank seeking authorization of the confirmed transaction from an institution associated with the payment card or account.

12. A method as claimed in claim 11 wherein the identification code is stored in a central registry.

13. A method as claimed in claim 12 wherein the central registry informs the vendor's bank of the card or account number.

14. A method as claimed in claim 12 wherein the vendor's bank sends the identification code to the central registry which seeks authorization from the institution on behalf of the vendor.

15. A method as claimed in any one of claims 11 to 14 wherein the institution is the customer's bank, credit card company or a utility company.

16. A method as claimed in any one of the preceding claims wherein the identification code is in a compatible format to the payment card or account number.

17. A method as claimed in any one of the preceding claims wherein the customer provides, at the time the transaction occurs, an identifier which identifies a transaction using the method.

18. A method as claimed in claim 17 wherein the identifier comprises modified name information of the payment card or account.

19. A method as claimed in claim 17 wherein the identifier forms part of the identification code.

20. A method as claimed in any one of the preceding claims wherein at the time the transaction occurs, the customer provides payment card expiry date information or a substitute therefor.

21. A method as claimed in any one of the preceding claims wherein the payment card is a physical card.

22. A method as claimed in any one of claims 1-20 wherein the payment card is a virtual card.

23. A method as claimed in any one of the preceding claims wherein the data network is the Internet.

24. A method of modifying a payment card transaction over a data network in which a customer supplies payment card information to a vendor on-line, said information comprising a payment card number, a card name and a card expiry date and the information is supplied by the customer completing a virtual form to be sent to the vendor, the form having fields of a fixed configuration to receive the information, the modification comprising the steps of, prior to a transaction using the method, assigning and advising the customer of an identification code corresponding to the payment card number to be used in place thereof and storing the identification code in association with the card number; and
at the time the transaction occurs, determining if a said identification code has been sent by the customer and if so, establishing the card number from the identification code, communicating with the customer telephonically to confirm the transaction and obtaining an authorization of the confirmed transaction using the card number and, if not, seeking authorization of the transaction directly, and communicating the authorization to the vendor.

26. Apparatus for performing the method of any one of the preceding claims.
